(19) United States
(12) Patent Application Publication
(10) Pub. No.: US 2016/0241684 A1
(43) Pub. Date: Aug. 18, 2016

(54) METHOD AND APPARATUS FOR LINK DISCOVERY AMONG DOMAINS

(71) Applicant: ELECTRONICS AND TELECOMMUNICATIONS RESEARCH INSTITUTE, Daejeon (KR)

(72) Inventors: Chang Gyu LIM, Daejeon (KR); Tae Il KIM, Daejeon (KR); Soo Myung PARK, Daejeon (KR); Jong Hyun LEE, Daejeon (KR)

(21) Appl. No.: 14/919,939

(22) Filed: Oct. 22, 2015

(30) Foreign Application Priority Data
Feb. 13, 2015 (KR) 10-2015-0022149

(51) Int. Cl. H04L 29/08; H04L 12/741

(52) U.S. Cl. CPC H04L 69/324; H04L 45/74

(57) ABSTRACT

A method and apparatus for link discovery among domains, the method including receiving a link discovery packet from a second switch in a second domain, generating a response packet with respect to the link discovery packet, and transmitting the response packet to the second switch, wherein the link discovery packet is generated by a transmission controller to control the first domain in order to detect a link between the second switch and the first switch in a first domain.

### CROSS-REFERENCE TO RELATED APPLICATION

This application claims the priority benefit of Korean Patent Application No. 10-2015-0022149, filed on Feb. 13, 2015, in the Korean Intellectual Property Office, the disclosure of which is incorporated herein by reference.

### BACKGROUND

1. Field of the Invention

Embodiments relate to a method of link discovery among switch domains managed by different controllers in a split architecture network.

2. Description of the Related Art

A software defined network (SDN) may control, manage, and record a communication flow using software for a network control. The SDN is used for an effective control and virtualization of network resources in various fields. The SDN is provided in a plurality of switch domains. Links of switches need to be detected in order to manage topology of the switch domains by a controller. In order to detect the links between the switch domains using a related art, an additional resource or protocol may be required. Accordingly, an effective method of detecting links among switch domains using related protocols and resources is required.

### SUMMARY

According to an aspect, there is provided a transmission controller to control a first domain, including a packet generator configured to generate a link discovery packet, a packet transmitter configured to transmit the link discovery packet to a first switch in the first domain, a packet receiver configured to receive, from the first switch, a response packet with respect to the link discovery packet, and a link manager configured to detect, based on the response packet, a link between the first switch and a second switch in a second domain.

The response packet may be generated by a reception controller to control the second domain.

The first switch and the second switch may transfer the link discovery packet and the response packet through a channel for data traffic.

The response packet may include information indicating that the first switch is connected to the second domain.

The transmission controller to control the first domain may further include a packet detector configured to detect the response packet among packets received by the packet receiver.

The link manager may be configured to detect, based on the response packet, a two-way link between the first switch and the second switch.

The link discovery packet may be transmitted from the first switch to the reception controller through the second switch.

The response packet may be transmitted from the second switch to the packet receiver through the first switch.

The link discovery packet may be generated according to a link layer discovery protocol (LLDP).

According to another aspect, there is also provided a reception controller to control a second domain, including a packet receiver configured to receive a link discovery packet from a second switch in the second domain, a packet generator configured to generate a response packet with respect to the link discovery packet, and a packet transmitter configured to transmit the response packet to the second switch.

The link discovery packet may be generated by a transmission controller to control a first domain in order to detect a link between the second switch and a first switch in the first domain.

The first switch and the second switch may transfer the link discovery packet and the response packet through a channel for data traffic.

The packet generator may include information indicating that the first switch is connected to the second domain in the response packet.

The link discovery packet may be transmitted from the first switch to the reception controller through the second switch.

The response packet may be transmitted to from the second switch the packet receiver through the first switch.

According to still another aspect, there is also provided a method of link discovery of a transmission controller to control a first domain, the method including generating a link discovery packet transmitting the link discovery packet to a first switch in the first domain, receiving, from the first switch, a response packet with respect to the link discovery packet generated by a reception controller to control a second domain, and detecting, based on the response packet, a link between the first switch and a second switch in the second domain.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating configurations of switch domains according to an embodiment;

FIG. 2 is a diagram illustrating a transmission controller and a reception controller according to an embodiment;

FIG. 3 is a flowchart illustrating a method of link discovery of a transmission controller according to an embodiment; and

FIG. 4 is a flowchart illustrating a method of link discovery of a reception controller according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Example embodiments will now be described more fully with reference to the accompanying drawings in which example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. Like reference numerals in the drawings denote like elements, and thus their description may be omitted.

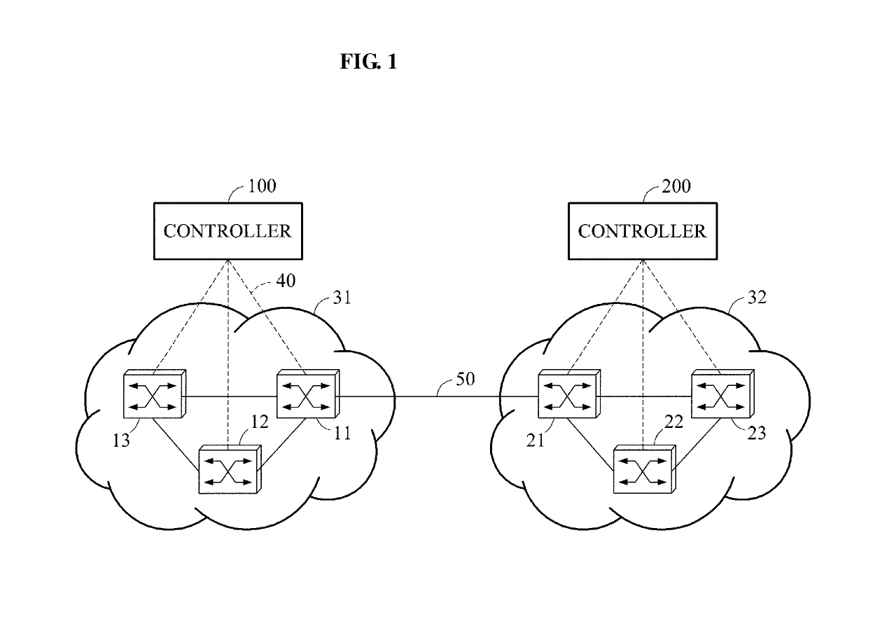

FIG. 1 is a diagram illustrating configurations of switch domains according to an embodiment.

Referring to FIG. 1, a domain 31 controlled by a controller 100 and a domain 32 controlled by a controller 200 are illustrated. The domain 31 includes switches 11, 12, and 13, and the domain 32 includes switches 21, 22, and 23.

Dissimilar to a conventional network architecture that combines a data area and a control area, a split architecture network, such as a software defined network (SDN), may divide the two areas into the switches 11, 12, 13, 21, 22, and 23, and the controllers 100 and 200.

The controllers 100 and 200 may collect information from the switches 11, 12, 13, 21, 22, and 23, calculate appropriate transmission determinations, and transmit control instructions required for a packet transmission to the switches 11, 12, 13, 21, 22, and 23. An open flow may be used as a protocol for connecting the controllers 100 and 200 and the switches 11, 12, 13, 21, 22, and 23.

The controller 100 may manage the domain 31 including the switches 11, 12, and 13. The controller 100 may detect a link among the switches 11, 12, and 13 to manage a topology of the domain 31. The link indicates a connection relationship among the switches 11, 12, and 13. For example, the controller 100 may detect a link among the switches 11, 12, and 13 according to a link discovery protocol such as a link layer discovery protocol (LLDP).

The controller 100 may detect a link of the domain 31 and the domain 32. For example, the controller 100 may detect a link of the domain 31 and the domain 32 by obtaining topology information on the domain 32 from the controller 200. Also, the link of the domain 31 and the domain 32 may be detected by obtaining the topology information on the domain 32 from a controller in a higher level of the controllers 100 and 200.

In order for the controller 100 to obtain the topology information on the domain 32 from the controller 200, a protocol needs to be added between the controller 100 and the controller 200. Also, in order for the controller 100 to obtain the topology information on the domain 32 from the controller in high level, a controller needs to be added in a higher level. Accordingly, a method of link discovery among switch domains using related protocol and resource is required.

Referring to FIG. 1, a connection 40 between the controller 100 and the switches 11, 12, and 13 is illustrated in dotted lines. Also, a connection 50 among the switches 11, 12, 13, 21, 22, and 23 is illustrated in solid lines.

A protocol for communications among the controllers 100 and 200, and the switches 11, 12, 13, 21, 22, and 23 may be applied to the connection 40. The connection 50 may include internal connections among the switches 11, 12, and 13 in the domain 31, internal connections among the switches 21, 22, and 23 in the domain 32, and external connections between the switch 11 of the domain 31 and the switch 21 of the domain 32. An in-band communication through a channel for data traffic may be applied to the connection 50.

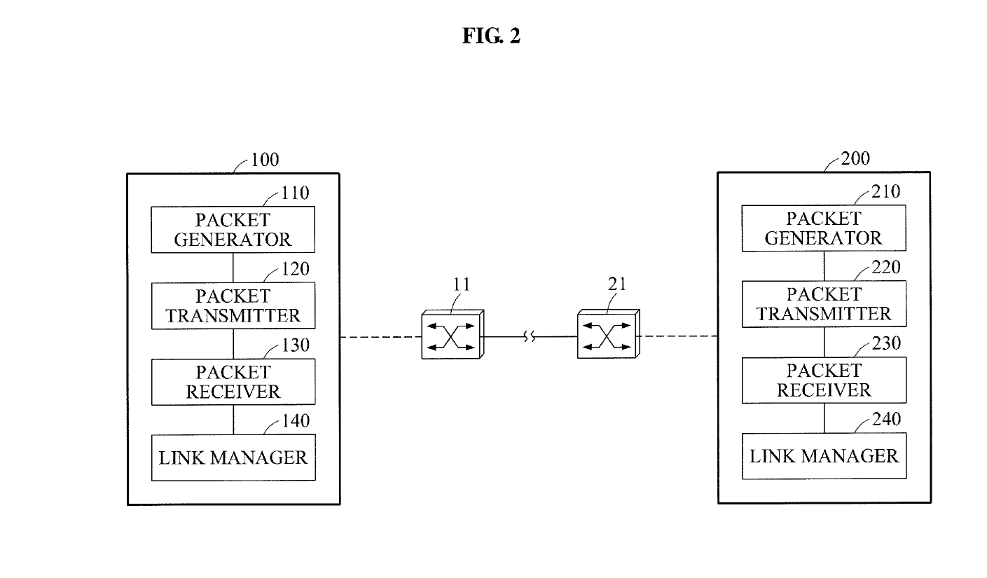

FIG. 2 is a diagram illustrating a transmission controller and a reception controller according to an embodiment.

Referring to FIG. 2, the controller 100 includes a packet generator 110, a packet transmitter 120, a packet receiver 130, and a link manager 140. The controller 200 includes a packet generator 210, a packet transmitter 220, a packet receiver 230, and a link manager 240. The packet generator 110, the packet transmitter 120, the packet receiver 130, the link manager 140, the packet generator 210, the packet transmitter 220, the packet receiver 230, and the link manager 240 may be provided in at least one of a hardware module or a software module. Here, the hardware module refers to as a processor, a memory, and a communication module.

Hereinafter, an external link refers to a link between a first switch in a first domain and a second switch in a second domain. For example, an external link refers to a link between the switch 11 and the switch 21. Conversely, an internal link refers to a link among switches in a same domain. For example, an internal link refers to a link between the switch 11 and the switch 12.

Hereinafter, an operation of detecting an internal link of the controller 100 will be described.

The packet generator 110 generates a link discovery packet for detecting an internal link. The link discovery packet may be generated according to a link discovery protocol such as a link layer discovery protocol (LLDP).

The packet transmitter 120 transmits a link discovery packet to the switch 11. Here, the packet transmitter 120 may transmit the link discovery packet using an open flow protocol.

The switch 11 transmits the link discovery packet to a port connected to the switch 12. Here, the link discovery packet may be transmitted through in-band communication.

The switch 12 transmits the link discovery packet to the packet receiver 130, and the packet receiver 130 receives the link discovery packet.

The link manager 140 may verify that the link discovery packet is generated by the packet generator 110 and recognize a presence of a one-way link from the switch 11 to the switch 12.

The controller 100 may verify a presence of a two-way link between the switch 11 and the switch 12 based on the following method.

The packet generator 110 generates a link discovery packet. The link discovery packet may be generated according to a link discovery protocol such as an LLDP.

The packet transmitter 120 transmits the link discovery packet to the switch 12. Here, the packet transmitter 120 may transmit the link discovery packet using the open flow protocol.

The switch 12 transmits the link discovery packet to a port connected to the switch 11. Here, the link discovery packet may be transmitted through in-band communication.

The switch 12 transmits the link discovery packet to the packet receiver 130.

The link manager 140 may verify that the link discovery packet is generated by the packet generator 110. Since the link manager 140 is aware of the presence of the one-way link between the switch 11 and the switch 12, the presence of the two-way link between the switch 11 and the switch 12 may be recognized. Concisely, similar operations need to be repeatedly performed in order to verify the presence of the two-way link.

Hereinafter, an operation of detecting an external link of the controller 100 will be described. A controller to perform link discovery is referred to as a transmission controller, and a controller to respond to the link discovery is referred to as a reception controller. Operations of the controllers 100 and 200 will be described in view of the controller 200 that responds to the link discovery, as a reception controller.

The packet generator 110 generates a link discovery packet for detecting an external link. The link discovery packet may be generated according to a link discovery protocol such as an LLDP.

The packet transmitter 120 transmits the link discovery packet to the switch 11. Here, the packet transmitter 120 may transmit the link discovery packet using an open flow protocol.

The switch 11 transmits the link discovery packet to the switch 21. The link discovery packet may be transmitted through in-band communication.

The switch 21 transmits the link discovery packet to the controller 200, and the packet receiver 230 of the controller 200 receives the link discovery packet. In an example, the controller 200 may further include a second packet detector. The second packet detector may detect a link discovery packet among packets received by the packet receiver 230. The second packet detector may detect the link discovery packet based on predetermined information included in the link discovery packet. For example, predetermined information may be at least one of information indicating that a link discovery packet is generated by the packet generator 110 or information indicating that a response packet is received through an external link.

The packet generator 210 generates, in response to the link discovery packet generated by the packet 110, a response packet with respect to the link discovery packet. The response packet may include information on a generator of the response packet. For example, a response packet may include information indicating that the response packet is generated by the packet generator 210. Also, the response packet may include information indicating that the first switch is connected to the second domain. Concisely, the packet generator 210 may include information indicating that the switch 11 is connected to the domain 32 in the response packet. In an example, a response packet may use an arrival media access control (MAC) address of the link discovery packet as an MAC address of a predetermined multicast. For example, the MAC address of the multicast may be “01:23:00:00:00:10”. In another example, a new EtherType indicating that the switch 11 is connected to the domain 32 in the response packet may be defined. Here, the EtherType may be defined to an L2 frame.

The packet transmitter 220 transmits the response packet to the switch 21. The switch 21 transmits the response packet to the switch 11, through a port having received the link discovery packet. Here, the link discovery packet may be transmitted though in-band communication.

The switch 11 transmits the response packet to the packet transmitter 130, and the packet transmitter 130 receives the response packet with respect to the link discovery packet. In an example, the controller 100 may further include a first packet detector. The first packet detector may detect a response packet among packets received by the packet receiver 130. The first packet detector may detect the response packet based on predetermined information included in the response packet. For example, predetermined information may be at least one of information indicating that a response packet is generated by the packet generator 210, information indicating that the response packet is received through an external link, or information indicating that the first switch is connected to the second domain.

The link manager 140 detects, based on the response packet, an external link between the switch 11 and the switch 21. Since the controller 100 having received the response packet indicates two-way communication between the switch 11 and the switch 21, the controller 100 may detect the external link as a two-way link. Accordingly, an additional packet transmission to verify that the detected link is a two-way link is not required.

In order to detect an external link, the controller 200 may also perform the aforementioned operations of the controller 100, and the controller 100 may perform the aforementioned operations of the controller 200. In this example, the controller 200 is referred to as a transmission controller, and the controller 100 is referred to as a reception controller.

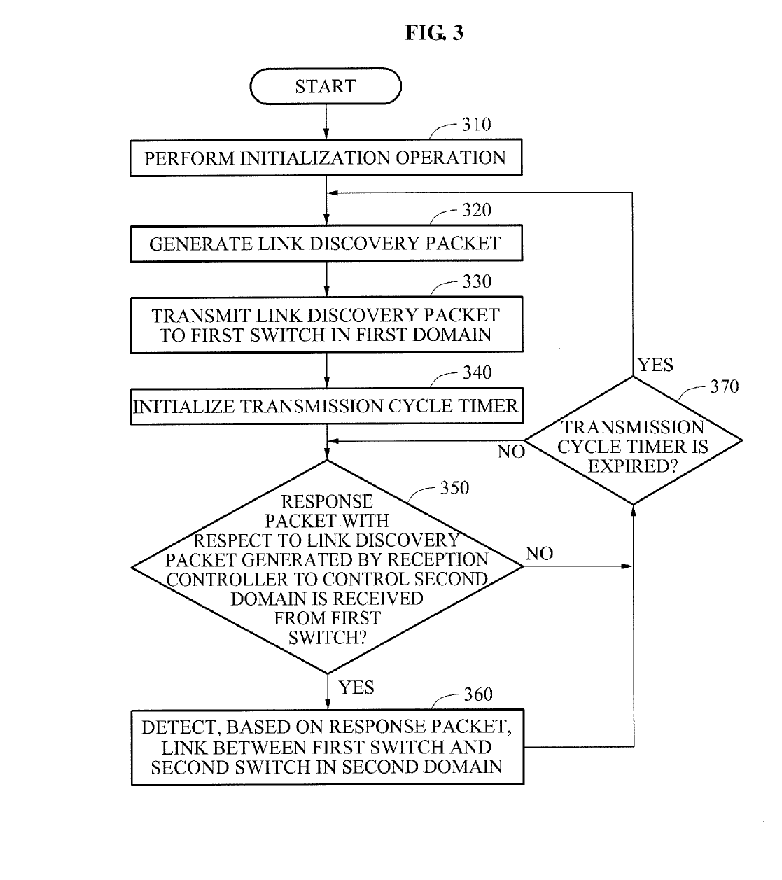

FIG. 3 is a flowchart illustrating a method of link discovery of a transmission controller according to an embodiment.

Referring to FIG. 3, in operation 310, the transmission controller performs an initialization operation.

In operation 320, the transmission controller generates a link discovery packet. The link discovery packet may be generated according to a link discovery protocol such as an LLDP.

In operation 330, the transmission controller transmits the link discovery packet to a first switch in a first domain. For example, a first domain may be the first domain 31 in FIG. 1, and a first switch may be the switch 11 in FIG. 1. In this example, the link discovery packet may be transmitted using an open flow protocol.

In operation 340, the transmission controller initializes a transmission cycle timer. The transmission cycle timer is for transmitting the link discovery packet according to a predetermined cycle. The transmission controller may recognize a transmission failure of a link discovery packet or a reception failure of a response packet through the transmission cycle timer. Also, the transmission controller may cyclically transmit the link discovery packet through the transmission cycle timer.

In operation 350, the transmission controller determines that the response packet is received from the first switch. The response packet may be generated by a reception controller in response to the link discovery packet. When the response packet is received, the transmission controller performs operation 360. When the response packet is not received, the transmission controller performs operation 370. The transmission controller may detect the response packet among a plurality of received packets. The transmission controller may detect the response packet based on predetermined information included in the response packet.

In operation 360, the transmission controller detects, based on the response packet, a link between the first switch and a second switch in a second domain. The transmission controller may update link management information based on the detected link. For example, link management information may include topology information among switches. The transmission controller may perform operation 370 in response to detecting the link between the first switch and the second switch in the second domain. In operation 370, the transmission controller determines that the transmission cycle timer is expired. When the transmission cycle timer expires, the transmission controller performs operation 330. When the transmission cycle timer is not expired, the transmission controller performs operation 350.

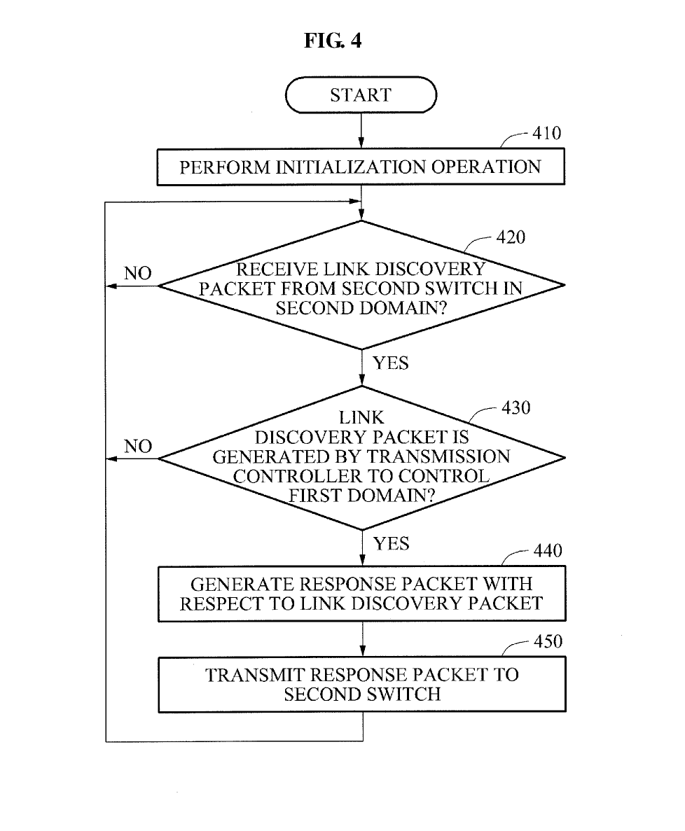

FIG. 4 is a flowchart illustrating a method of link discovery of a reception controller according to an embodiment.

Referring to FIG. 4, in operation 410, the reception controller performs an initialization operation.

In operation 420, the reception controller receives a link discovery packet from a second switch in a second domain. For example, the second domain may be the domain 32 in FIG. 1, and the second switch may be the first switch 21 in FIG. 1. The link discovery packet may be transmitted through in-band communication.

In operation 430, the reception controller determines that the link discovery packet is generated by a transmission controller to control the first domain. The reception controller may detect the link discovery packet among a plurality of received packets. The reception controller may detect the link discovery packet based on predetermined information included in the link discovery packet, and determine that the link discovery packet is generated by the transmission controller to control the first domain.

In operation 440, the reception controller generates a response packet with respect to the link discovery packet. The response packet may include information indicating that the first switch is connected to the second domain. For example, the packet generator 210 may include information indicating that the switch 11 is connected to the domain 32 in the response packet.

In operation 450, the reception controller transmits the response packet to a second switch. Here, the response packet may be transmitted using an open flow protocol.

As described above, in order to detect links between switch domains based on a related art, an additional resource, for example, a controller in a higher level, or a protocol among controllers may be required. However, according to an embodiment, the links among the switch domains may be detected using related protocol and resource. Also, a connection state of actual links may be accurately detected through in-band communication.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A transmission controller to control a first domain, comprising:
a packet generator configured to generate a link discovery packet;
a packet transmitter configured to transmit the link discovery packet to a first switch in the first domain;
a packet receiver configured to receive, from the first switch, a response packet with respect to the link discovery packet; and
a link manager configured to detect, based on the response packet, a link between the first switch and a second switch in a second domain,
wherein the response packet is generated by a reception controller to control the second domain.

2. The transmission controller of claim 1, wherein the first switch and the second switch transfer the link discovery packet and the response packet through a channel for data traffic.

3. The transmission controller of claim 2, wherein the channel is a channel for in-band communication.

4. The transmission controller of claim 1, wherein the response packet comprises information indicating that the first switch is connected to the second domain.

5. The transmission controller of claim 1, further comprising:
a packet detector configured to detect the response packet among packets received by the packet receiver.

6. The transmission controller of claim 1, wherein the link manager is configured to detect, based on the response packet, a two-way link between the first switch and the second switch.

7. The transmission controller of claim 1, wherein the link discovery packet is transmitted from the first switch to the reception controller through the second switch.

8. The transmission controller of claim 1, wherein the response packet is transmitted from the second switch to the packet receiver through the first switch.

9. The transmission controller of claim 1, wherein the link discovery packet is generated according to a link layer discovery protocol (LLDP).

10. A reception controller to control a second domain, comprising:
a packet receiver configured to receive a link discovery packet from a second switch in the second domain;
a packet generator configured to generate a response packet with respect to the link discovery packet; and
a packet transmitter configured to transmit the response packet to the second switch,
wherein the link discovery packet is generated by a transmission controller to control a first domain in order to detect a link between the second switch and a first switch in the first domain.

11. The reception controller of claim 10, wherein the first switch and the second switch transfer the link discovery packet and the response packet through a channel for data traffic.

12. The reception controller of claim 10, wherein the packet generator comprises information indicating that the first switch is connected to the second domain in the response packet.

13. The reception controller of claim 10, wherein the link discovery packet is transmitted from the first switch to the reception controller through the second switch.

14. The reception controller of claim 10, wherein the response packet is transmitted to from the second switch the packet receiver through the first switch.

15. A method of link discovery of a transmission controller to control a first domain, the method comprising:
generating a link discovery packet;
transmitting the link discovery packet to a first switch in the first domain;
receiving, from the first switch, a response packet with respect to the link discovery packet generated by a reception controller to control a second domain; and
detecting, based on the response packet, a link between the first switch and a second switch in the second domain.
